(19) United States
(12) Patent Application Publication
(10) Pub. No.: US 2013/0048888 A1
(43) Pub. Date: Feb. 28, 2013

(54) MOLDED RADIATION PROTECTION PART AND USE THEREOF

(71) Applicant: Christoph Kissenbeck, Krefeld (DE)

(72) Inventor: Christoph Kissenbeck, Krefeld (DE)

(73) Assignee: ROHR + STOLBERG GMBH, KREFELD (DE)

(21) Appl. No.: 13/695,934

(22) PCT Filed: May 2, 2011
(86) PCT No.: PCT/EP11/56926

§ 371 Date: Nov. 2, 2012

(30) Foreign Application Priority Data
May 5, 2010 (DE) 10 2010 028 576.5

(51) Int. Cl. G21F 1/12; G21F 3/00; B32B 3/24

(52) U.S. Cl. 250/515.1; 428/134; 428/76

(57) ABSTRACT

The invention relates to a molded radiation protection element. Provision is thereby made for the base body to be a plate-shaped, metal plate-shaped or film-shaped base body comprising a cut, which encompasses a square, rectangular or a different geometric shape and for the base body to encompass a first surface side, which is provided with a coating, which consists of a first non-metallic material.

### TECHNICAL FIELD

The invention relates to a molded radiation protection element and to the use thereof.

### STATE OF THE ART

The handling of ionizing radiation requires measures for protecting human life against to radiation damages. Such protective measures are required everywhere, where human contact with high doses of ionizing radiation is to be expected. This is in particular the case in the power and medical engineering. Special protective measures must thus be taken in the waste disposal of nuclear power plants for the workers.

U.S. Pat. No. 3,514,607 discloses a plate-shaped shielding material, which consists of lead as well as an additive of tin or barium. Such plates, however, are susceptible to corrosion and are difficult to decontaminate.

EP-A-1 288 969 discloses a molded radiation protection element, which comprises a plate made of lead, which is provided with a cover layer of tin or a tin-containing alloy on one or both sides. Such a cover layer on the lead plate provides for an easier decontamination of the molded radiation protection element. It is further prevented that the workers come into direct contact with the lead plate.

However, increasingly higher demands are made on molded radiation protection elements, which are to be used in the medical field, in particular in the medical therapy and diagnostics field. In particular, it is necessary for a cleaning of the surface not to be associated with a surface abrasion. Such a surface abrasion could be associated with a dissolution of tin ions, which could be associated with the formation of toxic organotin compounds, as is sometimes feared.

Special hygienic demands are further made on molded radiation protection elements in the medical field. In addition, the demands on the optical appearance of the cover layer are different than in the case of the waste disposal of nuclear power plants.

### ILLUSTRATION OF THE INVENTION: OBJECT, SOLUTION, ADVANTAGES

The invention is based on the object of specifying a molded radiation protection element comprising improved characteristics. In particular, a molded radiation protection element comprising an abrasion-resistant cover layer is to be specified which is radiation resistant, which offers effective corrosion protection and which satisfies high demands on hygiene and optical appearance. Uses of such molded radiation protection elements are to further be specified.

This object is solved by means of the features of claims 1 and 13. Advantageous embodiments of the invention follow from the subclaims.

According to the invention, provision is made for a molded radiation protection element, wherein the base body is a plate-shaped, metal plate-shaped or film-shaped base body comprising a cut, which encompasses a square, rectangular or a different geometric shape and wherein the base body encompasses a first surface side, which is provided with a first coating, which consists of a first non-metallic material.

Preferably, the coating completely covers the first surface. Preferably, the base body is a flexible base body.

Compared to the state of the art, the coating of the first surface side with the first non-metallic material offers a plurality of advantages. On the one hand, a corrosion of the lead surface of the base body is prevented and an improved wear resistance is attained as compared to uncoated lead. On the other hand, the coating of the non-metallic material provides a particularly suitable surface without abrasion and an advantageous optical impression to the molded radiation protection element. Due to these advantages, the molded radiation protection element according to the invention is suitable in particular for uses in the medical field, in particular in the therapy and diagnostics field. The molded radiation protection element according to the invention thus has improved hygienic, optical and handling characteristics.

In an embodiment of the invention, the coating can be completely or partially colored, which provides for an identification of the molded radiation protection element according to certain characteristics, for example the material thickness of the base body or of the alloy used for forming the base body.

The molded radiation protection element according to the invention can encompass a second surface side, which is provided with a coating, wherein the coating consists of a second non-metallic material. The first non-metallic material and the second non-metallic material can be the same or different, wherein it is preferred for the first and the second surface side to be coated with the same non-metallic material. Preferably, the coating completely covers the second surface side.

The thickness of the coating of a non-metallic material is preferably 10 nm to 100 μm, particularly preferably 1 to 50 μm and most preferably 10 to 30 μm. In particular, the latter range provides for a coating, which still covers and which fulfills the demand of being embodied as thin as possible for economic reasons, as well as the demand of encompassing a thickness, which provides deformations in particular of “deep drawing”. In the event that the base body is a film-shaped base body, the thickness of the coating of a non-metallic material is more preferably between 10 and 500 nm, particularly preferably between 50 and 250 nm.

Provision can further be made for all surfaces, that is, the two surface sides and the narrow sides of the base body, to be provided with a coating of non-metallic materials, wherein it is preferred for the narrow sides to be coated with the same non-metallic material as the first and/or the second surface side.

In addition to a coating of the non-metallic material, the molded radiation protection element encompasses an adhesive layer in an embodiment of the invention. The adhesive layer can be provided on a surface side of the base body, which does not encompass a coating of a non-metallic material. A practicable alternative of the invention provides for the coatings of a non-metallic material to be arranged between the respective surface side of the base body and the adhesive layer. In these cases, the adhesive layers serve as adhesion promoters between the surface of the coatings of the non-metallic material and other surfaces. The adhesive layer should completely cover the surface side of the base body, to which it is applied.

In the event that provision is made for a plurality of adhesive layers, they can be formed from the same or different adhesive compounds. Preferably, all of the adhesive layers are formed from the same adhesive compound.

The thickness of an adhesive layer preferably lies in the range from 10 nm to 800 μm, particularly preferably 1 μm to 500 μm, and most preferably 20 μm to 200 μm. In the event that the base body is a film-shaped base body (for example a lead film), the thickness of the adhesive layer is more preferably between 10 nm and 500 nm, particularly preferably between 50 nm and 250 nm.

A particularly preferred embodiment of the invention provides for the thickness of the adhesive layer to lie in a range of between 80 and 120 μm. It turned out that this layer thickness ensures a particularly good adhesion.

In a preferred embodiment, the first surface side of the base body is provided with a coating of the non-metallic material. The second surface side of the base body is coated with an adhesive layer. This adhesive layer is not covered by a coating of a non-metallic material. It is thus suitable for establishing an adhesive connection between the molded radiation protection element and a surface, which is to be lined with such a molded radiation protection element.

The base body consists of lead or a lead alloy. Due to its easy deformability and its low melting point, lead is one of the metals, which has been used the longest. The tensile strength of the lead should lie in the range of from 13 to 20 N/mm². The tensile strength of a lead alloy should lie in the range of from 13 to 40 N/mm². Lead and lead alloys are resistant against hydrochloric and sulfuric acids and act as shields against alpha, beta and gamma radiation. Lead has a thickness of 11.34 g/cm³. It can be recycled any number of times.

Preferably, the base body is a film-shaped base body. A film-shaped base body will also be identified as lead film hereinbelow.

Preferably, each of the surfaces, that is, the surface sides and narrow sides of the base body, is provided with a coating, so that the base body is wrapped across its entire surface.

In the instant invention, a non-metallic material refers to every material, which is not a metallic material. Preferably, the non-metallic material is an organic material, more preferably a polymeric material. Particularly preferably, the non-metallic material is chosen from the group, which comprises polymers, such as polyethylene, polypropylene, polyvinylchloride, polyethylene terephthalate and silicones. The non-metallic material should not be impacted or only slightly impacted by non-ionic radiation. It should further be UV-resistant.

The non-metallic material should encompass a processing temperature in the range of from −10 to 80° C. It should survive the spray test for 1008 h according to ECCA T8 with negative results. A rapid weathering for 1008 h according to QUV-UVB 313 chalking should result in a value of less than 10% overall degree 2E. A water immersion for 1008 h should have negative results. The cold deformability for 75 h at −10° C. according to QMH-4.10-QW 1156 should have negative results.

The adhesive layer is also a layer of a non-metallic material. However, in addition, it encompasses adhesive characteristics. Preferably, the adhesive layer is an adhesive compound on acrylate base, particularly preferably a poly(meth)acrylate adhesive compound, for example a modified acrylate adhesive compound.

On the one hand, the adhesive layer should have the necessary adhesive force to the surface of the base body as well as a high adhesive force on its outer side, so that the molded radiation protection element can be fastened to a wall surface by means of the adhesive layer. The adhesive force should not be impacted or only slightly impacted by non-ionic radiation. After an exposure to radiation of 1.5 MGy for 24 h, the adhesive force preferably reduces by maximally 40%. The adhesive force at the outer side of the adhesive layer should further also still have a sufficient level even in response to punctual maximum loads or in response to permanent radiation.

The adhesive is chosen as a function of the intended later use of the molded radiation protection element. The preferred adhesive compound on acrylate base adheres to metal, plastic, wood, paper, plasterboard, brickwork, plaster, concrete and coated surfaces, for example. The adhesives are typically provided as reel or flat material, so that adhesives can be laminated to the surfaces of the base body in a comparatively simple manner.

Every adhesive layer can be made up of layers of different adhesives, whereby a multi-layer, sandwich-like setup of the adhesive layer is obtained.

The processing temperature of the adhesive compound should lie in the range of from 10 to 25° C. The application temperature should lie in the range of from −40 to 100° C., briefly up to 200° C.

Preferably, the pull-off force of the adhesive compound from the surface of the base body (measured according to Afera 5001) lies at 23.1 N/25 mm, in the case of a sandwich-like setup of the adhesive layer at 20.1 N/25 mm.

The adhesive compound can encompass particles of lead or a lead alloy, so as to further improve the shielding characteristics of the molded radiation protection element according to the invention. The particles should thereby be distributed homogenously in the adhesive layer. Preferably, the particles have a particle size in the nano or micrometer range, preferably 10 to 500 nm, more preferably 10 to 100 nm.

At least one of the non-metallic materials and/or the adhesive layer can be bactericidal and/or can be equipped so as to be dirt-repellent. The durability of the non-metallic coating is improved in this manner, which is advantageous in particular in the case of uses in the medical field.

The coatings are preferably produced on the basis of modified acrylic resin dispersions.

The molded radiation protection element according to the invention is suitable in particular for use as shielding against ionizing radiation, in particular artificially ionizing radiation. In the event that the base body is embodied as a lead film, the molded radiation protection element according to the invention can be used for the internal lining of rooms like wallpaper due to the flexibility of the lead film, which is advantageous in particular in the medical field. The first surface side of the lead film is thereby preferably provided with a coating of an organic, preferably polymeric material, while the other, second surface side of the lead film is provided with a first adhesive layer. The molded radiation protection element is thus obtained as radiation protection film, which can be fastened to walls via the first adhesive layer in a simple manner. The coating of the non-metallic material is thereby arranged so as to face away from the wall. The characteristics of this coating make it possible to provide a room with a hygienic, abrasion-resistant, wear-resistant, dirt-repelling and UV-resistant lining.

### BRIEF DESCRIPTION OF THE DRAWINGS

The invention will be defined in more detail below by means of exemplary embodiments, which are not to limit the invention, with reference to the drawings.

FIG. 1 shows a schematic sectional view of a first embodiment of the molded radiation protection element according to the invention;

FIG. 2 shows a schematic sectional view of a second embodiment of the molded radiation protection element according to the invention;

FIG. 3 shows a schematic sectional view of a third embodiment of the molded radiation protection element according to the invention;

FIG. 4 shows a schematic sectional view of a fourth embodiment of the molded radiation protection element according to the invention;

FIG. 5 shows a schematic sectional view of a fifth embodiment of the molded radiation protection element according to the invention;

FIG. 6 shows a schematic perspective view of a sixth embodiment of the molded radiation protection element according to the invention comprising a coating, which is removed in sections; and

FIG. 7 shows a schematic sectional view of the sixth embodiment of the molded radiation protection element shown in FIG. 6 along a sectional line A-A in FIG. 6.

### BEST EMBODIMENTS OF THE INVENTION

The sectional view shown in FIG. 1 shows a cross section through a first embodiment of a film-shaped molded radiation protection element 1. The base body of the molded radiation protection element 1 is a lead film 2. The first, upper surface side 8 of the lead film 2 is provided completely with a coating 3 of a non-metallic material. For this purpose, the non-metallic material is laminated onto the first surface side of the lead film 2, for example by means of an extruder, by forming the coating 3. The second, lower surface side 9 of the lead film 2 is not coated. The narrow sides of the lead film 2 are also not coated, which is not necessary due to the small thickness of the lead film 2. A coating of the narrow sides with a coating of the non-metallic material can be provided, however.

The sectional view illustrated in FIG. 2 shows a cross section through a second embodiment of a film-shaped molded radiation protection element 1. The base body of the molded radiation protection element 1 is a lead film 2. The first, upper surface side 8 of the lead film 2 is completely covered with a first coating 3 of a non-metallic material. An adhesive layer 4, which completely covers the upper surface side 8 of the coating 3, is applied to the upper surface side 8 of the coating 3. For this purpose, the non-metallic material is initially laminated onto the first surface side 8 of the lead film 2 by forming the coating 3 and the adhesive mass is subsequently laminated onto the first coating 3 of the non-metallic material by forming the adhesive layer 4, in each case for example by means of an extruder. The second, lower surface side 9 of the lead film 2 is not coated. The narrow sides of the lead film 2 are also not coated, which is not necessary due to the small thickness of the lead film 2. A coating of the narrow sides of the lead film 2 with a coating of the non-metallic material can be provided, however.

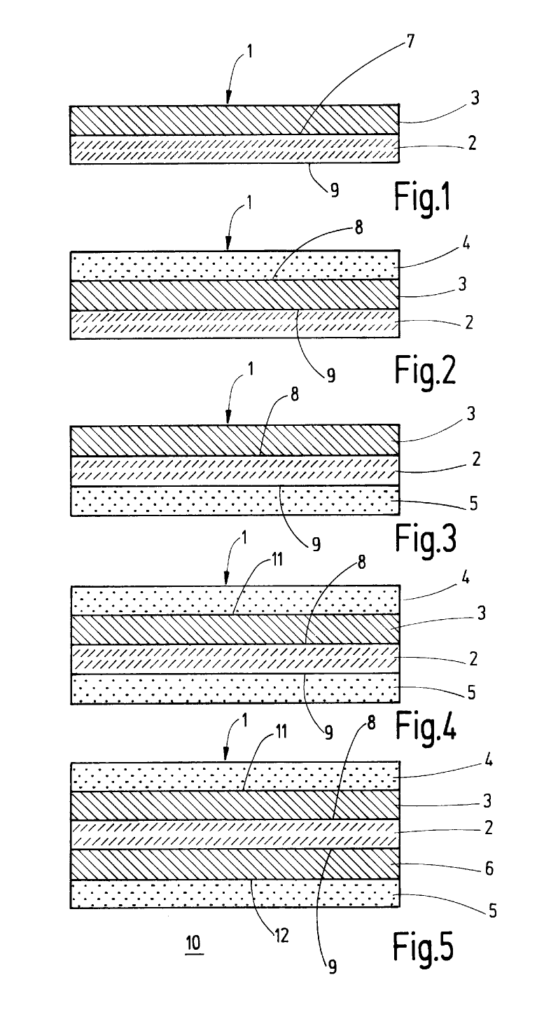

The sectional view shown in FIG. 3 shows a cross section through a third embodiment of a film-shaped molded radiation protection element 1. The base body of the molded radiation protection element 1 is a lead film 2. A coating 3 of a non-metallic material, which completely covers the upper surface side of the lead film, is applied to the first, upper surface side 8 of the lead film 2. An adhesive layer 5, which completely covers the lower surface side of the lead film 2, is applied to the second, lower surface side 9 of the lead film 2. For this purpose, either the adhesive compound is initially laminated onto the second surface side of the lead film 2 by forming the adhesive layer 5 and the non-metallic material is subsequently laminated onto the first surface side of the lead film by forming the coating 3, in each case for example by means of an extruder, or vice versa. A simultaneous lamination of both surface sides of the lead film 2 is also possible. The narrow sides of the lead film 2 are not coated, which is not necessary due to the small thickness of the lead film 2. The adhesive layer 5 provides for an adhesion of the molded radiation protection element onto a wall. A coating of the narrow sides with a coating of the non-metallic material can be provided, however, so that the molded radiation protection element 1 is wrapped by non-metallic material and adhesive across its entire surface.

The sectional view shown in FIG. 4 shows a cross section through a fourth embodiment of a film-shaped molded radiation protection element 1. The base body of the molded radiation protection element 1 is a lead film 2. The first, upper surface side 8 of the lead film 2 is covered completely with the first coating 3 of a non-metallic material. An adhesive layer 4, which completely covers the upper surface side, that is, the side of the coating 3, which faces away from the lead film 2, is applied to the third, upper surface side 11 of the coating 3. For this purpose, the non-metallic material is initially laminated onto the first surface side 8 of the lead film 2 by forming the coating 3 and the plastic compound is subsequently laminated onto the coating 3 by forming the adhesive layer 4, in each case for example by means of an extruder. An adhesive layer 5, which completely covers the lower surface side 9 of the lead film 2, is applied onto the second, lower surface side 9 of the lead film 2. The lamination of the adhesive compound 5 onto the lower surface side of the lead film 2 can be carried out prior to, after, or simultaneously to the lamination of the upper surface side 8. The adhesive layer 5 provides for an adhesion of the molded radiation protection element onto a wall, which is suggested in FIG. 5 at 10, whereas the adhesive layer 4 can serve as adhesive surface for objects and devices, for example. The narrow sides of the lead film 2 are not coated, which is not necessary due to the small thickness of the lead film 2. A coating of the narrow sides with a coating of the non-metallic material can be provided, however, so that the molded radiation protection element 1 is wrapped by non-metallic material and adhesive across its entire surface.

The sectional view shown in FIG. 5 shows a cross section through a fifth embodiment of a film-shaped molded radiation protection element 1. The base body of the molded radiation protection element 1 is a lead film 2. The first, upper surface side 8 of the lead film 2 is covered completely with a first coating 3 of non-metallic material. An adhesive layer 4, which completely covers the upper surface side 11 of the coating 3, is attached to the upper surface side 11 of the coating 3. For this purpose, the non-metallic material is initially laminated onto the first surface side 8 of the lead film 2 by forming the coating 3 and the adhesive compound is subsequently laminated onto the coating 3 by forming the adhesive layer 4, in each case for example by means of an extruder. The second, lower surface side 9 of the lead film 2 is covered completely with a coating 6 of a non-metallic material. An adhesive layer 5, which completely covers the lower surface side 12 of the coating 6, is applied onto the fourth, lower surface side 12 of the coating 6 of a non-metallic material. For this purpose, the non-metallic material is initially laminated onto the lower surface side 12 of the lead film 2 by forming the coating 6 and the adhesive mass is subsequently laminated onto the lower surface side 12 of the coating 6 by forming the adhesive layer 5, in each case by means of an extruder. The lamination of the lower surface side 9 of the lead film 2 can be carried out prior to, after, or simultaneously to the lamination of the upper surface side 8 of the lead film 2. The narrow sides of the lead film are not coated, which is not necessary due to the small thickness of the lead film 2. A coating of the narrow sides with a coating of the non-metallic material can be provided, however, so that the molded radiation protection element 1 is wrapped by non-metallic material across its entire surface and additionally, in particular across its entire surface, also by adhesive.

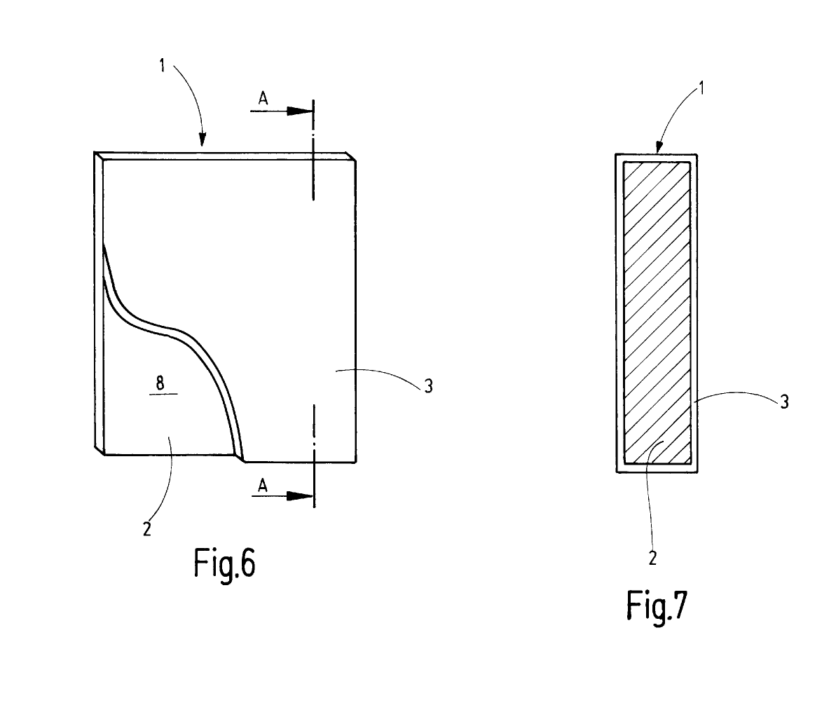

The sixth exemplary embodiment of the molded radiation protection element 1 shown in FIGS. 6 and 7 shows a plate-shaped base body 2. The surface sides 8, 9 of the base body 2 as well as the narrow sides of the base body 2 are covered with coatings 3 of a non-metallic material, so that the base body 2 is wrapped completely by the non-metallic material. It goes without saying that a molded radiation protection element comprising a plate-shaped base body can also have the setup shown in FIGS. 1 to 5, wherein a lead plate is used instead of the lead film.

### LIST OF REFERENCE NUMERALS

1 molded radiation protection element

2 base body

3 first coating of non-metallic material

4 first adhesive layer

5 second adhesive layer

6 second coating of non-metallic material

8 first surface side

9 second surface side

10 wall

11 third surface side

12 fourth surface side

1. A molded radiation protection element, comprising a base body of lead or a lead alloy, wherein the base body is a plate-shaped, metal plate-shaped or film-shaped base body including a cut, which encompasses a square, rectangular or a different geometric shape and that the base body encompasses a first surface side, which is provided with a first coating, which consists of a first non-metallic material.

2. The molded radiation protection element according to claim 1, wherein the base body encompasses a second surface side, which is provided with a second coating, wherein the coating consists of a second non-metallic material, wherein the first non-metallic material and the second non-metallic material are the same or different.

3. The molded radiation protection element according to claim 1, wherein the first surface side and/or the second surface side of the base body are provided with an adhesive layer.

4. The molded radiation protection element according to claim 1, wherein each coating of a non-metallic material is arranged between the respective surface side of the base body and the adhesive layer.

5. The molded radiation protection element according to claim 1, wherein the base body is a flexible base body.

6. The molded radiation protection element according to claim 1, wherein the base body is wrapped by the first non-metallic material and/or the second non-metallic material across its entire surface.

7. The molded radiation protection element according to claim 1, wherein the first non-metallic material and the second non-metallic material are chosen from the group, which comprises polymers, such as polyethylene, polypropylene, polyvinylchloride, polyethylene terephthalate and silicones.

8. The molded radiation protection element according to claim 1, wherein the coating of the non-metallic material encompasses a thickness in the range of from 10 nm to 100 μm, in particular 10 to 30 μm.

9. The molded radiation protection element according to claim 1, wherein the adhesive layer is an adhesive compound on acrylate base.

10. The molded radiation protection element according to claim 1, wherein the adhesive layer encompasses a thickness in the range of from 10 nm to 800 μm, in particular 80 to 120 μm.

11. The molded radiation protection element according to claim 1, wherein the coatings are produced on the basis of modified acrylate resin dispersions.

12. A use of the molded radiation protection element according to claim 1 for shielding against the impact of ionizing radiation.

13. The use according to claim 12, wherein the molded radiation protection element encompasses a film-shaped base body, wherein the first surface side of the base body is coated with a non-metallic material and wherein the second surface side of the plate-shaped, metal plate-shaped or film-shaped base body is coated with an adhesive layer.

14. The use according to claim 13, wherein the molded radiation protection element is used as wallpaper, wherein the surface side of the wallpaper, which encompasses the adhesive layer, faces a, in particular, lined wall.
